(19) United States
(12) Patent Application Publication
(10) Pub. No.: US 2007/0065024 A1
(43) Pub. Date: Mar. 22, 2007

(54) Decoding method and decoding apparatus

(76) Inventor: Satoru Todate, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/512,224

(22) Filed: Aug. 30, 2006

(30) Foreign Application Priority Data
Sep. 21, 2005 (JP) 2005-273780

(51) Int. Cl. G06K 9/36

(52) U.S. Cl. 382/233

(57) ABSTRACT

A decoding method and apparatus for decoding compressed main data and, after that, outputting the decoded main data with other data being superposed thereon. The decoding apparatus consists of an input unit for inputting the compressed main data, a memory unit for storing compressed sub data, a switch unit for selecting and outputting the compressed main data and the compressed sub data at a predetermined timing, a decoding unit for decoding the compressed main data and the compressed sub data which are outputted from the switch unit, and a superposition unit for outputting the decoded main data and the decoded sub data in superposition.

### INCORPORATION BY REFERENCE

The present application claims priority from Japanese application JP2005-273780 filed on Sep. 21, 2005, the content of which is hereby incorporated by reference into this application.

### BACKGROUND OF THE INVENTION

The present invention relates to a decoding method and apparatus for decoding compressed data, and after that, outputting the decoded data such that another data is superposed thereon.

Conventionally, in hotels, buildings, convenience stores, financial institutions, or public facilities such as dam and road, an image surveillance system has been set up for the purpose of crime deterrent or accident prevention. In this system, images taken by a surveillance camera set up at each surveillance point are transferred to the surveillance center via a network. Then, the transferred camera images allow surveillance personnel to perform the integrated surveillance.

The camera image data, however, is significantly large in data amount, thus necessitating a time for the data transfer. Accordingly, in some cases, the surveillance personnel find it impossible to confirm an image at an abnormality occurrence time in a short while. In view of this situation, the following methodology has been proposed: Namely, the images at a normal time are stored into the surveillance center in advance. Next, if an abnormality has occurred, the differences between the abnormality-occurrence time image and the normal time images are extracted. Moreover, only the above-described differential data is transferred to the network, then superposing the differential data on the normal time images (refer to, e.g., JP-A-11-25383).

### SUMMARY OF THE INVENTION

In a surveillance system, in order to identify images photographed by surveillance cameras (which, hereinafter, will be referred to as “main data”), it is required to superpose many pieces of information such as appliance information on the surveillance cameras and information on the corresponding surveillance points (which, hereinafter, will be referred to as “sub data”). The main data arriving from the surveillance cameras is transmitted in a predetermined compression-encoded form. This compression is performed in order to enhance the network transfer efficiency. In contrast thereto, the sub data is usually treated as non-compressed data. As a result, storing the sub data has required a large amount of memory capacity.

As described above, in the conventional surveillance system, storing the sub data has required the large amount of memory capacity. For example, if a SDTV-scheme image superposition system is taken an example, the image data equivalent to 1 frame in the SDTV scheme is equal to about 700 KB. Accordingly, if it is assumed that the image superposition of one-half of the 1 frame is carried out, the data to be superposed needs to be accumulated or stored by about 350 KB. Moreover, if the image superposition is implemented by switching between 10 patterns of to-be-stored images, the memory capacity of as much as about 3. 5 MB becomes necessary. This situation has resulted in a problem that a reduction in the memory capacity must be implemented in the process of carrying out small-size implementation and low-price implementation of the apparatus.

The present invention has been made by focusing attention on the above-described circumstances. Accordingly, an object of the present invention is to provide a decoding apparatus which, when decoding compressed data and outputting the decoded data with other data superposed thereon, realizes reduction in the necessary memory capacity, thereby achieving the small-size implementation and low-price implementation of the apparatus.

In order to accomplish the above-described object, a decoding apparatus according to an aspect of the present invention comprises an input unit for inputting first data compressed by a predetermined compression scheme, a memory unit for storing second data compressed by the same compression scheme as the predetermined compression scheme, a switch unit connected to the input unit and the memory unit for selecting and outputting the compressed first data and the compressed second data at a predetermined timing, a decoding unit connected to the switch unit for decoding the compressed first data and the compressed second data outputted from the switch unit, and a superposition unit for outputting the decoded first data and the decoded second data in superposition.

In the above-described configuration, the second data is stored in advance in the compression-encoded form. Next, the compression-encoded second data is decoded at the predetermined timing so as to be superposed on the decoded first data. In comparison with, e.g., the case where the sub data as the second data is stored without being compressed, this configuration makes it possible to reduce the necessary memory capacity.

A decoding apparatus according to another aspect of the present invention comprises an input unit for inputting first data compressed by a first compression scheme, a memory unit for storing second data compressed by a second compression scheme which is different from the first compression scheme, a first decoding unit connected to the input unit for decoding the compressed first data, a second decoding unit connected to the memory unit for decoding the compressed second data, a switch unit connected to the first and second decoding units for selecting and outputting the decoded first data and the decoded second data at predetermined timings, and a superposition unit connected to the switch unit for outputting the selected and outputted first data and second data in superposition.

In the above-described configuration, when the compression scheme for the first data and the compression scheme for the second data are different from each other, there are provided the decoding units corresponding to the respective compression schemes so that the second data decoded by the second decoding unit is superposed on the first data decoded by the first decoding unit. With the configuration, no limitation is posed on the compression scheme for the main data as the compressed first data and on the compression scheme for the sub data as the compressed second data. Consequently, the employment of this configuration makes it possible to enhance the general versatility.

A decoding method according to still another aspect of the present invention comprises the steps of selecting input of compressed first data, inputting the first compressed data into a decoding unit, decoding the first compressed data inputted, storing the decoded first compressed data into a first memory unit, selecting input of compressed second data at a predetermined timing, reading the second compressed data out of a second memory unit, and inputting the second compressed data into the decoding unit or into another decoding unit, decoding the second compressed data, storing the decoded second compressed data into the first memory unit, and outputting the stored decoded first compressed data and decoded second compressed data in superposition.

According to the present invention, it becomes possible to provide a decoding apparatus which, when decoding compressed data and then outputting the decoded data with other data superposed thereon, can realize a reduction in the necessary memory capacity, thereby achieving the small-size implementation and low-price implementation of the apparatus.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram for illustrating the configuration of a general surveillance system;

FIG. 2 is a block diagram for illustrating an embodiment of a decoding apparatus according to the present invention;

FIG. 3 is a flow chart for illustrating the procedure and contents of the operation of the decoding apparatus illustrated in FIG. 2;

FIG. 4 is a time chart for illustrating the decoding operation in the decoding apparatus illustrated in FIG. 2; and

FIG. 5 is a block diagram for illustrating the configuration of a decoding apparatus according to another embodiment of the present invention.

### DESCRIPTION OF THE INVENTION

Hereinafter, referring to the drawings, the explanation will be given below concerning embodiments of the present invention. Through all of the drawings, same reference numerals will be used to designate similar members.

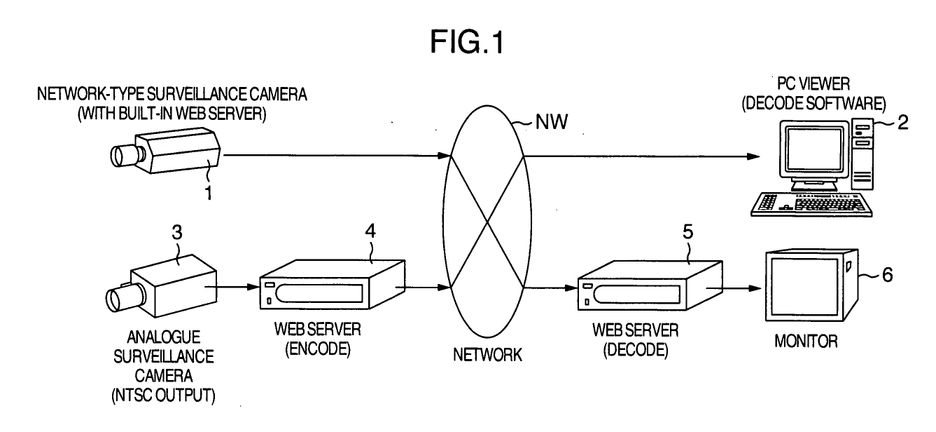

FIG. 1 is a schematic diagram for illustrating the configuration of a general surveillance system. A network-type surveillance camera 1 and an analogue surveillance camera 3 are set up at each surveillance point or site, thereby taking images of a surveillance target, the images being main data. After applying a compression processing to the images taken, the network-type surveillance camera 1 sends out the compressed images to a network NW. The images taken by the analogue surveillance camera 3 are supplied to a WEB server 4, then being subjected to the compression processing in this WEB server 4. After that, the compressed images are sent out to the network NW. Meanwhile, in the surveillance center, a PC viewer 2, a WEB server 5, and a monitor 6 are placed. These devices decode and display the compression-processed camera images transmitted via the network NW as described above. A decoding apparatus according to the present invention is mounted in the PC viewer 2 and the WEB server 5.

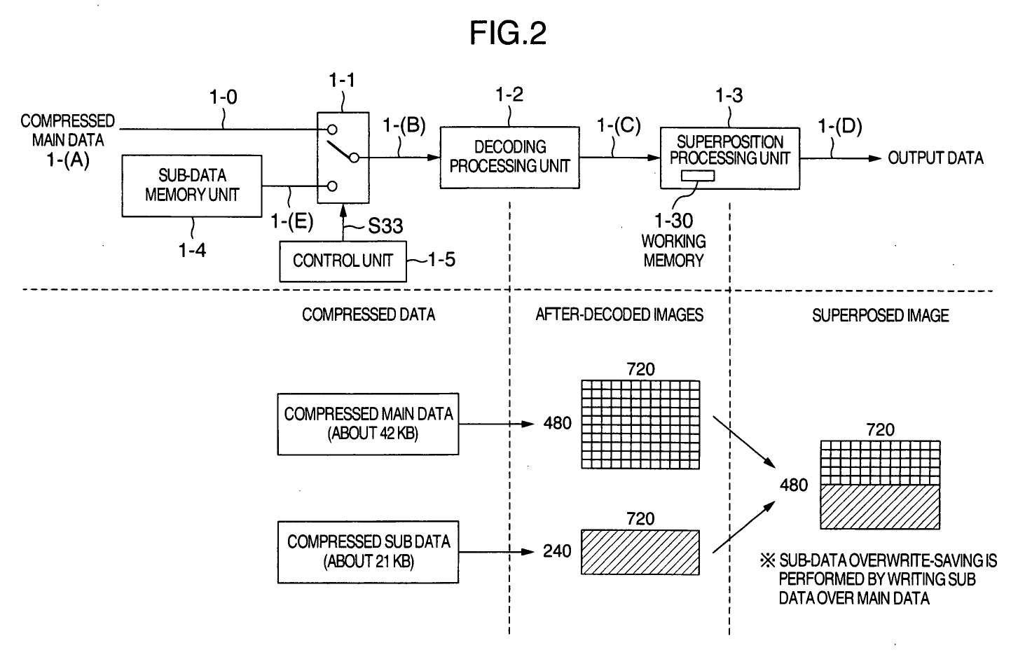

FIG. 2 is a block diagram for illustrating an embodiment of the decoding apparatus according to the present invention. This decoding apparatus includes a compressed-data input line (i.e., input unit) 1-0, a compressed-data switch unit 1-1, a decoding processing unit 1-2, a superposition processing unit 1-3, a sub-data memory unit 1-4, and a control unit 1-5. One set or plural sets of sub data (such as appliance (machine) information on the cameras and information on each surveillance point or site) to be superposed on the main data is stored in the sub-data memory unit 1-4 in a compression-encoded form. The compressed-data switch unit 1-1 selects and outputs, at a predetermined timing, either of the compressed main data received via the network NW which, hereinafter, will be simply referred to as “compressed main data” and the compressed sub data read out of the sub-data memory unit 1-4 which, hereinafter, will be simply referred to as “compressed sub data”. This selection operation in the compressed-data switch unit 1-1 is specified by the control unit 1-5. The sub data to be read out may also be specified by the control unit 1-5 in selecting the sub-data memory unit 1-4.

Also, the decoding processing unit 1-2 performs a decoding processing on the compressed main data and the compressed sub data that are selected and outputted from the compressed-data switch unit 1-1. The superposition processing unit 1-3 includes a working memory 1-30 such as a RAM. Then, using the working memory 1-30, the superposition processing unit 1-3 temporarily stores the decoded main data supplied from the decoding processing unit 1-2, superposes the subsequently supplied decoded sub data on the decoded main data on the working memory 1-30, and outputs the decoded main data and sub data in superposition to the monitor 6 or the like.

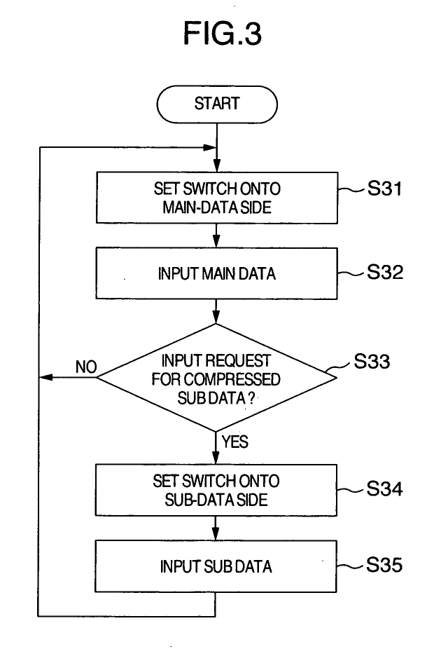

Next, the explanation will be given of the operation of the decoding apparatus configured in this way. FIG. 3 is a flow chart for illustrating the procedure and contents of the operation of this decoding apparatus.

Here, it is assumed that the compressed main data 1-(A) is received from the network NW. Also, it is assumed that, as illustrated in FIG. 2, data desired to be superposed on output data 1-(D) is data equivalent to one-half of the frame in the SDTV scheme. Its data size is equal to about 350 KB. A compression-encoding processing according to, e.g., the JPEG (Joint Photographic imaging coding Experts Group) is applied to this data to be superposed and the resultant compression-encoded data is stored in advance in the sub-data memory unit 1-4 as the compressed sub data 1-(E). In this case, if the setting for the compression-encoding processing is made to a high picture-quality, the data size of the compressed sub data 1-(E) becomes about 21 KB. Also, it is assumed that both of the compressed main data 1-(A) and the compressed sub data 1-(E) have been compressed by the same compression-encoding scheme.

First, explanation will be given of the basic operation which performs no superposition processing. Having received the compressed main data 1-(A) from the network NW, the compressed-data switch unit 1-1 inputs the compressed main data 1-(A) to the decoding processing unit 1-2. The decoding processing unit 1-2 performs decoding processing on the compressed main data 1-(A), then outputting the main data in the baseband as decompressed data 1-(C). The decompressed data 1-(C) is then inputted to the superposition processing unit 1-3 and temporarily stored in the working memory 1-30. After that, the decompressed data 1-(C) is outputted as the output data 1-(D) in response to an output request from the system.

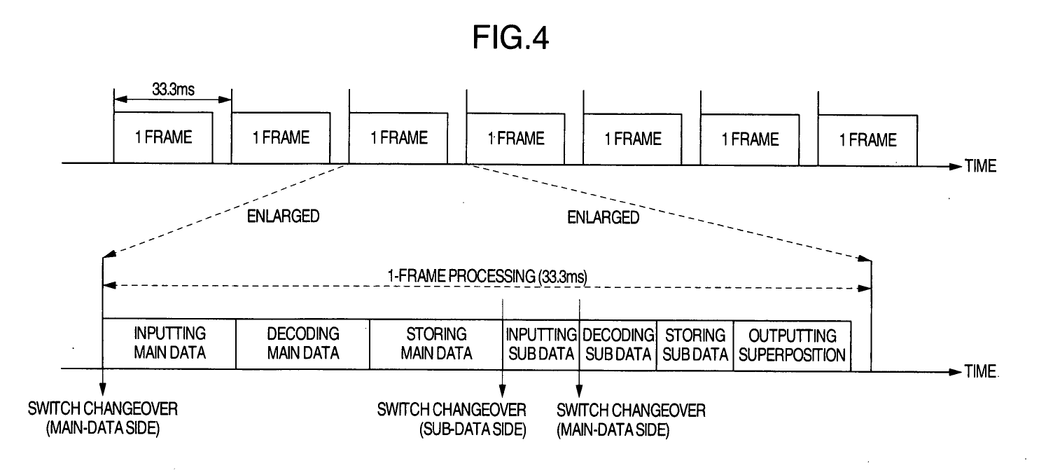

Next, explanation will be given of the operation which performs the superposition processing. FIG. 3 is a flow chart for illustrating the procedure and contents of the operation of the decoding apparatus illustrated in FIG. 2. Also, FIG. 4 is a time chart for illustrating the decoding operation in this decoding apparatus.

In FIG. 3, in step S31, the compressed-data switch unit 1-1 is set to the input side of the compressed main data 1-(A). In step S32, the compressed main data 1-(A) received through the above-described procedure is decoded, then being inputted to the superposition processing unit 1-3 as the decompressed data 1-(C).

Here, in step S33, the processing goes to a step S34 at a predetermined compressed-data input timing. In step S34, the compressed-data switch unit 1-1 is switched to the input side of the compressed sub data 1-(E). Then, in step S35, desired compressed sub data 1-(E) is outputted from the sub-data memory unit 1-4, then being inputted into the decoding processing unit 1-2. The decoding processing unit 1-2 performs decoding processing on the compressed sub data 1-(E) and outputs the sub data in the baseband as decompressed data 1-(C) which in turn is outputted to the superposition processing unit 1-3. The superposition processing unit 1-3 outputs superposed data which results from superposing the sub data on the temporarily-stored main data.

Referring to FIG. 4, explanation will be given of the above-described superposition processing procedure in more detail.

When the input of the compressed main data is selected, the compressed main data is inputted to the decoding processing unit 1-2 and decoded therein. Then, the decoded main data is stored in the working memory 1-30 which is provided in the superposition processing unit 1-3. Subsequently, if the input request for the compressed sub data is made (i.e., the step S33 in FIG. 3), the compressed-data switch unit 1-1 is switched to the sub-data side to select the input of the compressed sub data. Accordingly, the desired compressed sub data is read out of the sub-data memory unit 1-4, then being inputted to the decoding processing unit 1-2 so as to be decoded. The decoded sub data is stored in the working memory 1-30 in the superposition processing unit 1-3. In the superposition processing unit 1-3 the stored main data and sub data are superposed on each other and outputted

As having been described so far, in the above-described embodiment, the sub data to be superposed is compression-encoded, then being stored in the sub-data memory unit 1-4 in advance. And, depending on the requirements (e.g., after the decoding processing for the 1-frame or more main data has been finished, or at a specified interrupt time or a specified timing), the compressed sub data is decoded so as to be superposed on the earlier-decoded main data. This configuration makes it possible to tremendously reduce the memory capacity, thereby allowing achievement of the small-size implementation and low-price implementation of the system.

Take for example a SDTV-scheme image superposition system, the image data equivalent to 1 frame in the SDTV scheme is equal to about 700 KB. Accordingly, if it is assumed that the image superposition of one-half of the 1 frame is to be carried out, the data to be superposed needs to be accumulated by about 350 KB. Moreover, if the image superposition is implemented by switching between 10 patterns of image superposition, the memory capacity of as much as about 3. 5 MB becomes necessary. In the above-described embodiment, if the setting for the sub-data compression-encoding processing is set to a high picture-quality, the data size of the compressed sub data 1-(E) becomes equal to about 21 KB. Consequently, in this example, about a 94% reduction in the memory capacity becomes accomplishable.

Note that this invention is not limited to the above-described embodiment. For example, although the image compressed data has been selected as the target compressed data, it is also possible to deal with various types of information such as voice data or character data. Also, the JPEG has been selected as the compression-encoding scheme for the target compressed data, it is also possible to deal with the other compression-encoding schemes.

In the present embodiment, it has been assumed that the compressed main data 1-(A) is the compressed data which is received from a transmission infrastructure such as the network NW. As the compressed main data 1-(A), however, whatever compressed data is allowable as long as it is the compressed data which can be inputted from the outside of the decoding apparatus. Therefore the compressed main data may include not only the input from the transmission infrastructure, but also an input from a storage appliance such as RAM and so on.

Further, although it has been assumed that the compressed sub data 1-(E) is stored in advance in the sub-data memory unit 1-4, the compressed sub data 1-(E) may also be updated using the data received from a transmission infrastructure such as the network during the operation of the surveillance system, or the compressed input data from a storage appliance such as RAM.

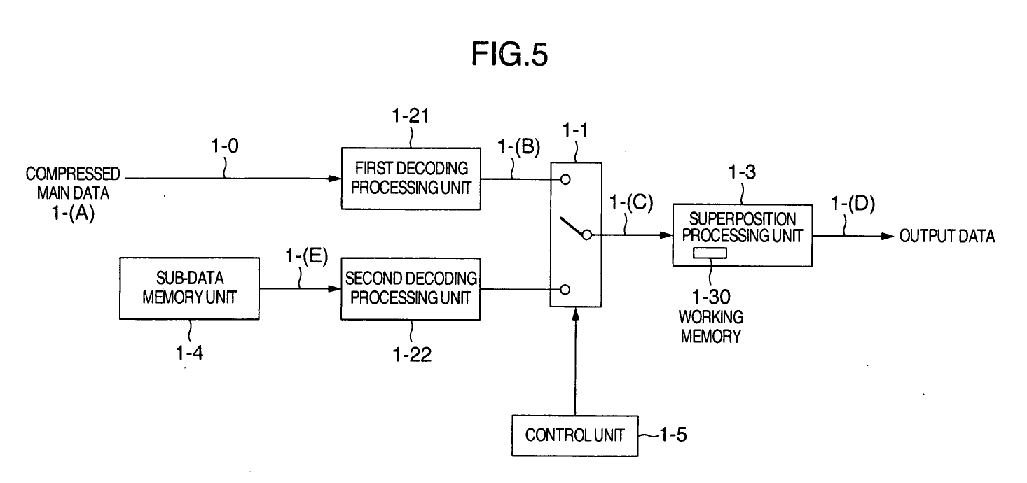

Further, in the present embodiment, it has been assumed that the compressed main data 1-(A) and the compressed sub data 1-(E) are the data compression-encoded by the same compression-encoding scheme. However, mutually different compression-encoding schemes may be used. FIG. 5 illustrates the configuration of a decoding apparatus in this case. A first decoding processing unit 1-21 performs decoding processing corresponding to the compression-encoding scheme for the compressed main data 1-(A). A second decoding processing unit 1-22 performs decoding processing corresponding to the compression-encoding scheme for the compressed sub data 1-(E). Furthermore, after the decoding processing of the respective compressed data have been finished, an input switching between the respective decoded data is performed by the compressed-data switch unit 1-1. Also, the configuration in FIG. 5 is of course also applicable to the case where the same compression-encoding scheme is used for the compressed main data 1-(A) and compressed sub data 1-(E). This allows the decoding of the respective compressed data to be performed in the decoding processing units 1-21 and 1-22, respectively. Consequently, it becomes possible to increase the entire processing speed.

Also, while only one kind of the sub data to be superposed is assumed in the embodiments above, thereby requiring the use of only one sub-data memory unit 1-4 involving only one kind of the compressed sub data 1-(E), it is also possible to provide an increased number of sub-data memory units and compressed sub data correspondingly, when the number of the kinds of the data to be superposed is increased in response to a system request. In this case, the compressed-data switch unit 1-1 may be equipped with a switching function corresponding to the number of the plural kinds of compressed sub data. Alternatively, the only one sub-data memory unit may be configured to store plural kinds of compressed sub data in such a manner that arbitrary compressed sub data is readable so that desired sub data may be read by the control unit 1-5 (FIG. 2).

Here, the configuration of the decoding apparatus according to the present invention is not necessarily limited to the above-described ones. Instead, various configurations are also employable. Further, the present invention can also be provided as, e.g., methods or schemes for executing the processing according to the present invention, or programs for implementing these methods or schemes, or record media for recording the programs. Also, the present invention can also be provided as various apparatuses or systems.

Also, the application field of the present invention is not necessarily limited to the surveillance system as described above. Instead, the present invention is applicable to various fields.

Also, the respective types of processing performed in the decoding apparatus according to the present invention may also be configured as the following configurations: Namely, e.g., a configuration where, in a hardware resource including a processor and memory, the processor executes a control program stored in a ROM (Read Only Memory), thereby controlling the processing, or, e.g., a configuration where respective types of function units for executing the processing are configured as independent hardware circuits.

Also, the present invention can also be interpreted as and implemented in a computer-readable record medium, such as a floppy (TM) disk or CD (Compact Disk)-ROM which stores the above-described control program therein, or as the control program itself. The processing according to the present invention can be carried out by inputting the control program into the computer from the record medium, and causing the processor to execute the program.

In conclusion, the present invention is not limited to the above-described embodiments as illustrated. Instead, in its carry-out stage, the present invention can be embodied by modifying its configuration elements within the range not departing from its essence and spirit. Also, by appropriately combining the plural configuration elements disclosed in the above-described embodiments, it becomes possible to adapt the invention in various forms. For example, several configuration elements may be deleted from all the configuration elements disclosed in the embodiments. Furthermore, the configuration elements according to the different embodiments may be combined appropriately.

1. A decoding apparatus, comprising:
an input unit which inputs first data compressed by a predetermined compression scheme,
a memory unit which stores second data compressed by a compression scheme which is the same as said predetermined compression scheme,
a switch unit connected to said input unit (1-0) and said memory unit (1-4), which selects and outputs said compressed first data and said compressed second data at a predetermined timing,
a decoding unit connected to said switch unit, which decodes said compressed first data and said compressed second data which are outputted from said switch unit, and
a superposition unit which outputs said decoded first data and said decoded second data in superpositon.

2. The decoding apparatus according to claim 1, wherein said memory unit stores, as said compressed second data, a plurality of kinds of display contents in a manner in which arbitrary one of said display contents is selectable.

3. The decoding apparatus according to claim 1, wherein said compressed first data includes an image taken by a surveillance camera, and
said compressed second data includes at least one of appliance information on said surveillance camera and information on a surveillance point.

4. A decoding apparatus, comprising:
an input unit which inputs first data compressed by a first compression scheme,
a memory unit which stores second data compressed by a second compression scheme which is different from said first compression scheme,
a first decoding unit connected to said input unit, which decodes said compressed first data,
a second decoding unit connected to said memory unit, which decodes said compressed second data,
a switch unit connected to said first and second decoding units, which selects and outputs said decoded first data and said decoded second data at predetermined timings, and
a superposition unit connected to said switch unit, which outputs said selected and outputted first data and second data in superposition.

5. The decoding apparatus according to claim 4, wherein said memory unit stores, as said compressed second data, a plurality of kinds of display contents in a manner in which an arbitrary one of said plurality of kinds of display contents is selectable.

6. The decoding apparatus according to claim 4, wherein said compressed first data includes an image taken by a surveillance camera, and
said compressed second data includes at least one of appliance information on said surveillance camera and information on a surveillance point.

7. A decoding method, comprising the steps of:
selecting input of compressed first data,
inputting said first compressed data to a decoding unit,
decoding said first compressed data inputted,
storing said decoded first compressed data in a first memory unit,
selecting input of compressed second data at a predetermined timing,
reading said second compressed data out of a second memory unit and inputting said second compressed data to said decoding unit or to another decoding unit,
decoding said second compressed data,
storing said decoded second compressed data in said first memory unit, and
outputting said decoded and stored first and second compressed data in superposition.

8. The decoding method according to claim 7, wherein said first compressed data and said second compressed data are compressed by the same compression scheme, both of said first and second compressed data being decoded in said decoding unit.

9. The decoding method according to claim 7, wherein
said first compressed data and said second compressed data are compressed by mutually different compression schemes, respectively,
said first compressed data being decoded in said decoding unit and said second compressed data being decoded in said another decoding unit.

10. The decoding method according to claim 7, wherein said compressed first data includes an image taken by a surveillance camera,
said compressed second data including at least one of machine information on said surveillance camera and information on a surveillance point.
